(19) United States
(12) Patent Application Publication
(10) Pub. No.: US 2012/0284167 A1
(43) Pub. Date: Nov. 8, 2012

(54) Performance Testing Tool for Financial Applications

(76) Inventor: Siddharth Dubey, Malden, MA (US)

(21) Appl. No.: 13/504,215

(22) PCT Filed: Nov. 11, 2010
(86) PCT No.: PCT/IN10/00737

§ 371 Date: Jul. 17, 2012

(30) Foreign Application Priority Data
Nov. 11, 2009 (IN) 2772/CHE/2009
Nov. 11, 2010 (IN) PCT/IN2010/000737

(51) Int. Cl. G06Q 40/04

(52) U.S. Cl. 705/37

(57) ABSTRACT

The present invention provides a n-tier architecture for a performance based testing tool and an associated method for trading and financial applications. The performance benchmarking tool of the present invention is configured to create multiple load generating clients, monitor and control it through a single agent process. The invention determines latencies of individual subsystems by subscribing to ticker plants and allows for online monitoring of latencies and controlling of multiple clients based on predefined message types.

### FIELD OF TECHNOLOGY

The instant invention generally relates to testing tools and more particularly relates to a class of performance testing tools and associated method pertaining to performance benchmarking of financial applications based on the Financial Information Exchange protocol (FIX).

### BACKGROUND

The Financial Information Exchange protocol (FIX) is an open specification intended to streamline electronic communications in the financial securities industry. For example, FIX 4.2 is an open standard that specifies the way different financial applications, e.g. representing stock exchanges and brokerage companies communicate in a mutually understandable format. FIX supports multiple formats and types of communications between financial entities including email, texting trade allocation, order submissions, order changes, execution reporting and advertisements.

FIX is vendor-neutral and can improve business flow by:
Minimizing the number of redundant and unnecessary messages.
Enhancing the client base.
Reducing time spent in voice-based telephone conversations.
Reducing the need for paper-based messages, transaction and documentation.

The FIX protocol is session- and application-based and is used mostly in business-to-business transactions. (A similar protocol, OFX (Open Financial Exchange) is query-based and intended mainly for retail transactions.) FIX is compatible with nearly all commonly used networking technologies.

The instant invention provides a novel device (tool) and associated method thereof for performance bench marking of .the applications that communicate using FIX protocol.

### SUMMARY

The present invention provides a n-tier architecture for a performance based testing tool and an associated method for trading and financial applications. The performance benchmarking tool of the present invention is configured to create multiple load generating clients, monitor and control it through a single agent process.

In another embodiment, a method is disclosed to determine latencies of individual subsystems by subscribing to ticker plants.

In another embodiment the present invention allows clients to view latencies, message/order types, latency distributions through various reporting features.

In yet another embodiment, the present invention allows for online monitoring of latencies and controlling of multiple clients based on predefined message types.

### BRIEF DESCRIPTION OF THE DRAWINGS

FIG. 1 illustrates an overview of the exemplary architecture of the performance benchmarking tool of the present invention.

### DETAILED DESCRIPTION

The present invention is directed to a n-tier distributed performance testing infrastructure that comprises of various sub systems and/or tool components for generating, bulk orders/messages, monitoring order flow, measuring end-to-end latency, throughput and other performance measurements of trading and other financial applications that use FIX protocol standards for communication.

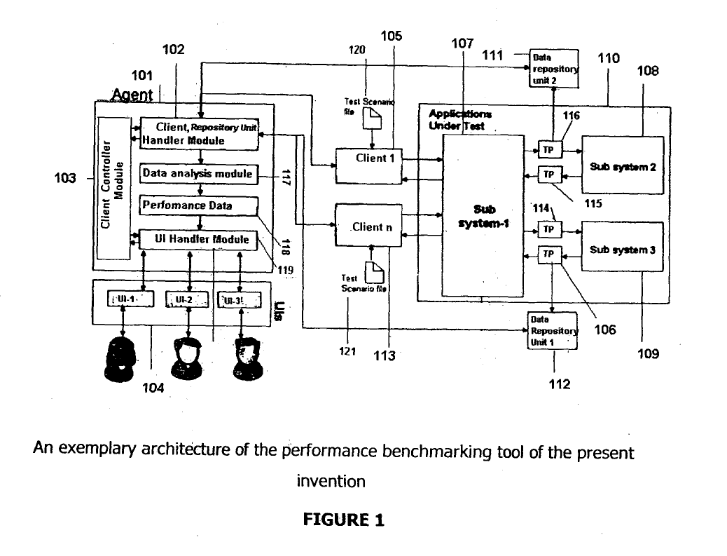

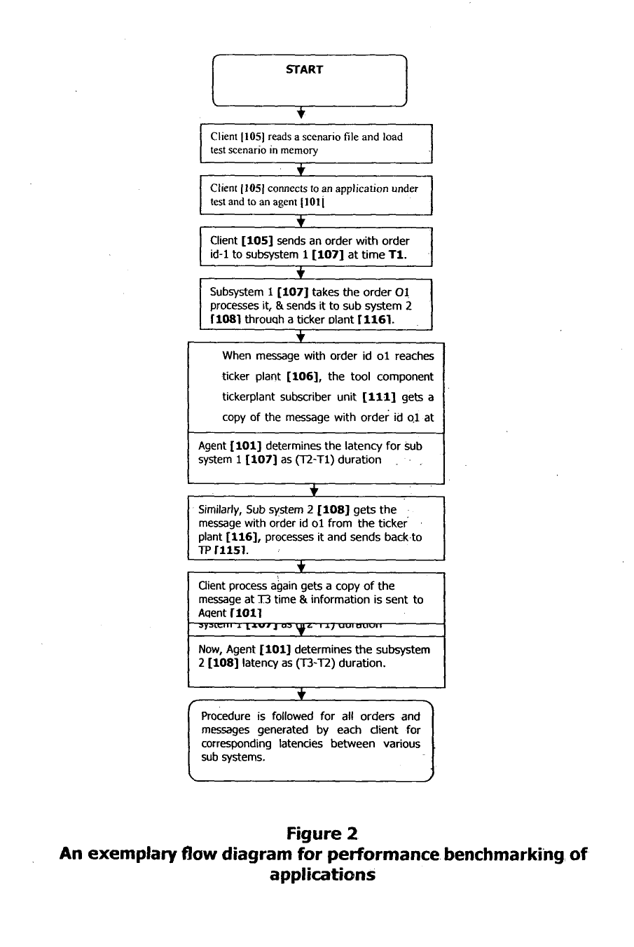

As shown in FIG. 1, the tool comprises of following different sub-systems or components:
1. Client Component [105,113]
2. Tickerplant subscriber Component [106,114,115,116]
3. Agent [101]
4. User Interfaces [104]

The various components of the exemplary infrastructure implemented to achieve the objectives of the present invention are now described in detail with reference to the corresponding drawings.

Client Component: This component is used to generate messages (related to financial transactions) i.e. load for the application under test. An exemplary client process that is followed in this regard is described herein. Client processes belonging to individual clients read the test scenario configuration files, connect to the application under test, start sending orders/messages and process incoming messages from the application under test. The client component of the present invention is adapted to read and understand the pre-defined scenario files and based on that it generates load for the application. The client processes of the instant invention are also configured to understand and interpret messages, generate different types of dynamic data based on predefined scenario configuration. The client component sends all inbound and outbound messages information to an agent process.

Tickerplant subscriber component [111,112]: Most of the financial applications sub systems communicate with each other using tickerplants. Ticker plants [106,114,115,116] are in-memory databases/data repository unit configured to act as a bridge for data exchange in between two applications or in between different application sub-systems. The Tickerplant subscriber component utilizes the tickerplants to determine the sub system level latencies. An exemplary communication process by making use of such ticker plants [106,114,115,116] is described herein. The [111,112] load tool component subscribes to various ticker plants [106,114,115,116] between each application sub system and listens for new order IDs and arrival timestamps. This information is published to a central agent [101]. This exemplary process is used to determine system level latencies.

Agent Component [101]: Different clients and ticker plants subscribe to a central agent [101] which acts as a central data collector and/or controller to various clients. The functionality provided by a typical agent [101] comprises performing data measurements and publishing all information to the end users through User interface [104] (described below). Agent [101] is also responsible for determining total no. of messages sent using different client based on their message types, total number of inbound messages that “application under test” responds with based on message types, latencies based on message types, latencies distributions based on message types, latencies based on the order destinations and latency distributions based on order destinations. Agent [101] comprises of below main logical/functional modules that are responsible for performing different operations—
i. Client, Data detection unit handler module [102] is responsible for managing the communication with different Clients and data detection unit related processes and for receiving and sending data to these application components.
ii. Data Analysis module [117] is responsible for processing the data received from clients and data detection unit related processes and for doing the calculation and further data analysis for performance statistics generation.
iii. Data Collection module [118] is responsible for maintaining and managing the analyzed data.
iv. User Interface Handler module is responsible managing the connection with User Interfaces and publishing the analyzed data to the User Interfaces.
v. Client Controller module [103] is responsible for maintaining the state related data for individual client processes. It is also responsible for processing the commands send by User Interfaces through User Interface handler module and then passing the control instructions accordingly to the clients.

User Interface component [104]: This component is used for connecting to an agent [101] and controlling and monitoring the test behavior. Using User Interface [104], all clients connected to the given agent [101] can be controlled for load generation variations and the tester would be able to see all the performance statistics.

The exemplary steps for performance testing an application using the load tool of the instant invention are described in detailed in the following paragraphs:
1. Message format configuration: Based on the type of messages that need to be sent to an application, a message format file is created that describes the content for each of those messages. This is referred to as format configuration file and also defines what data within the message needs to be static and what data needs to be dynamic. The dynamic data keeps on changing for each message. e.g.: the equity name, buy/sell quantity etc. Each dynamic data is given a reference name that is used later to assign value in the scenario configuration file. Using the messages configuration file, protocol version can be changed.

The different types of financial messages for which an application can report latencies comprise:
1. ACK (Acknowledgment messages): refers to an acknowledgment sent back to a client in response to an order sent by the client to a trading application.
2. Cancel messages: A message that is sent for indicating order cancel.
3. Part fill messages: If the orders that are sent cannot be completed in a single transactions (because of voluminous load and related reasons) then such orders are bifurcated/divided to be completed by next transaction. The messages that indicate this are called part fill messages.
4. Full-Fill messages: When the order quantities/load can be completed/matched in a single transaction, then system sends such Full Fill messages.
5. REJ messages: The preferred embodiment of the present invention provides for order reject messages in case the orders don't comply with business transaction policies. An exemplary violation of a business policy could be when someone sends a wrong equity name. In such cases system will generate order reject messages. The performance tool of the present invention can also monitor latencies for RD messages.
2. Design and configuration of the scenario files: The logical flow of test is created using scenario files. After messages format file is created, scenario files are developed based on type of test that needs to be run. The scenario file defines specifically the order, type of messages from the message configuration file that should be sent. The scenario file also specifies the datasets for dynamically changing data of messages. The client scenarios support different functions to accommodate different data types. For example, to generate random/sequential numbers it will have configuration about the rate at which messages need to be sent to application under test and the time after which order flow rate should get changed and the no. of messages after which the test should stop.
3. Configure the connection information: After scenario files have been developed, connection information is configured to specify host and port of the application under test where the client process should connect. Also, connection information needs to be specified for connecting to Agent process. (Who configures configuration information).
4. Running the test: After the entire configuration, agent process is brought up and clients are started. Using UI test performance, details can be viewed and clients can be controlled to change load behavior.

The following paras describe an exemplary Latency and performance data calculation mechanism.

An exemplary test infrastructure is explained with reference to FIG. 1. In the present scenario a client-1 [105] sends orders to sub-system 2 [108] through sub-system 1 [107] as per following exemplary steps.

Client-1[105]
reads scenario file and loads test scenario in memory
connects to application under test and connects to the agent [101].

Client [105] sends an order with order id-1 to subsystem 1 [107] at time T1. This information (the order id and the T1 timestamp) is also sent to agent process. Thereafter, Subsystem 1 [107] takes the order o1 and processes it, sends it to sub system 2 [108] through a ticker plant [116]. As soon as the message with order id o1 reaches ticker plant [106], the tool component KDB-2 [111] gets a copy of the message with order id o1 at time T2. This information is passed to Agent [101].
1. Agent [101] calculates the latency for sub system 1 [107] as (T2-T1) duration.
2. Sub system 2 [108] gets the message with order id o1 from the ticker plant [116] and processes it then sends back to TP [115]. The client process again gets a copy of the message at T3 time. This information is sent to Agent [101].
3. Agent [101] calculates the subsystem 2 [108] latency as (T3-T2) duration.
4. Sub system 1 [107] gets the message from ticker plant [106] and then processes it at sends the message back to client-1 [105] at time T4. This information is sent to Agent [101].
5. Agent [101] calculates the sub system 1 [107] latency as (T4-T3) duration.
6. Agent [101] calculates the order end to end latency for the inbound message type as (T4-T1) duration.
7. Agent [101] keeps track of, the number of messages, message types, messages per second and latency range information in memory and publishes all this information to the UIs [104]. This procedure is followed for all the orders and messages by each client.

The performance testing tool of the present invention is configured to replay the case data in predefined and controlled test environments. Thus, an already sent (or received) case data/order at a particular instant can be replayed again with same payload at any desired instance.

This ability to reproduce the production flow in a test environment allows for debugging, correction of uncaught issues and/or validating the newly generated data against the actual case data and thus helps in benchmarking.

The present invention allows for online monitoring of latencies and controlling of multiple clients based on predefined message types.

The present invention is not intended to be restricted to any particular form or arrangement, or any specific embodiment, or any specific use, disclosed herein, since the same may be modified in various particulars or relations without departing from the spirit or scope of the claimed invention herein shown and described of which the apparatus or method shown is intended only for illustration and disclosure of an operative embodiment and not to show all of the various forms or modifications in which this invention might be embodied or operated.

1. A performance benchmarking tool for financial applications, comprising:
a plurality of client modules configured to generate and interpret case data representing a plurality of orders, based on predetermined criteria, said client modules having a first independent process to handle and time stamp inbound messages and a second independent process to handle and time stamp outbound messages and to asynchronously offload said messages from the inbound independent processor and outbound independent processor to the client repository unit module, said client modules configured to interpret test scenarios to replay input data from static pre stored input data in time synchronized fashion;
one or more subscriber modules configured to act as a data sniffer in between application sub systems to capture and to asynchronously pass the message type and arrival timestamp information to client repository unit handlers to determine sub system latencies in real time.

2. (canceled)

3. The performance benchmarking tool as claimed in claim 1, wherein said one or more subscriber modules are configured to listen to newly generated case data with their associated identification data and their timestamps of arrival.

4. The performance benchmarking tool as claimed in claim 1, wherein said central unit comprises of:
Handler unit for managing communication among plurality of client modules and for receiving and sending data among different modules;
Data Analysis unit configured to process data received from client module(s) [105 ] [113] and to generate statistical analysis;
Data Collection unit for managing and maintaining analysed data;
User interface Handling Unit for managing connections with user interfaces and for publishing analyzed data to said user interfaces wherein said central unit [103] is configured to:
maintain state related data for individual clients;
process the commands received from user interfaces via user interface handling unit;
send said commands as control instructions to corresponding clients.

5. The performance benchmarking tool as claimed in claim 1, wherein latencies are determined for predefined messages, said messages comprise:
Acknowledgment message for acknowledging receipt of case data sent by a client;
Cancel Message for cancelling transmission of case data;
Part fill messages indicating division of orders that cannot be completed in a single transaction;
Full Fill messages indicating orders that can be completed in a single transaction;
Reject Messages indicating messages that do not comply with predefined policies.

6. The performance benchmarking tool as claimed in claim 1, wherein connection information is configured to specify host and port of the application under test.

7. A method for performance benchmarking of financial applications, comprising the steps of:
reading a scenario file and loading a test scenario in the memory by a configured processor of a plurality of client modules;
sending a case data representing an order with a predetermined identification tag at a predetermined instant T1 towards a subsystem one and a central unit, by the configured processor of the plurality of said client modules;
processing said case data at subsystem one;
forwarding said processed data towards a sub system two [108] via predefined memory units;
receiving a copy of said case data at one or more subscriber modules with said predetermined identification tag and said predetermined instant T1 at a new instant T2, as soon as said case data is received at said predefined memory units and forwarding said case data to the central unit
wherein central unit said is configured to determine latency of said subsystem one as a difference of said time instants T2 and T1.

8. The method for performance benchmarking of financial applications as claimed in claim 7, wherein said central controller is configured for tracking the count of case data, type and frequency of messages exchanged and latency range information at predefined memory units and to publish the information at predefined interfaces.

9. The method for performance benchmarking of financial applications as claimed in claim 7, wherein said client modules represent a discrete client whose performance is to be tested and are configured to send and/or receive said case data from/to said applications under test.

10. The method for performance benchmarking of financial applications as claimed in claim 7, wherein said one or more subscriber modules are configured to listen to newly generated case data with their associated identification data and their timestamps of arrival.

11. The method for performance benchmarking of financial applications as claimed in claim 7, comprising the steps of:
managing communication among the plurality of client modules and receiving and sending data among different modules by a Handler unit;
processing data received from the client modules and generating statistical analysis by a Data Analysis unit;
managing and maintaining analysed data by a Data Collection unit;
managing connections with user interfaces and publishing analyzed data to predefined user interfaces by a User interface Handling Unit,
wherein said central unit is configured for maintaining state related data for individual clients and processing the commands received from user interfaces via user interface handling unit.

12. The method for performance benchmarking of financial applications as claimed in claim 7, wherein latencies can be determined for predefined messages, said messages comprising:
Acknowledgment message for acknowledging receipt of -case data sent by a client;
Cancel Message for cancelling transmission of case data;
Part fill messages indicating division of orders that cannot be completed in a single transaction;
Full Fill messages indicating orders that can be completed in a single transaction;
Reject Messages indicating messages that do not comply with predefined policies.

13. The method for performance benchmarking of financial applications as claimed in claim 7, comprising the step of configuring connection information for specifying host and port of the application under test.

14. The method for performance benchmarking of financial applications as claimed in claim 7, comprising the step of online monitoring of said latencies and controlling of multiple clients based on predefined message types.
